(19) United States
(12) Patent Application Publication
(10) Pub. No.: US 2008/0309435 A1
(43) Pub. Date: Dec. 18, 2008

(54) NOISE FILTER

(75) Inventor: Han-Hao Wu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RICHWAVE TECHNOLOGY CORP., Taipei (TW)

(21) Appl. No.: 12/112,028

(22) Filed: Apr. 30, 2008

(30) Foreign Application Priority Data
Jun. 13, 2007 (TW) 96121386

(51) Int. Cl. H01P 1/20

(52) U.S. Cl. 333/204; 333/202; 333/208

(57) ABSTRACT

A noise filter connected to an LC oscillator is provided. The noise filter comprises a transmission line, a DC bias circuit, and a capacitor. The transmission line is connected to the LC oscillator. The DC bias circuit is connected to the transmission line and provides a bias current. The capacitor has one end connected between the transmission line and the DC bias circuit and the other end AC grounded and provides a path to AC ground to the transmission line. A length of the transmission line is odd times that of a quarter-wavelength of a secondary harmonic wave of the LC oscillator.

### BACKGROUND OF THE INVENTION

1. Field of the Invention

The invention relates to a noise filter and, in particular, to a noise filter with a transmission line to cancel noise thereof.

2. Description of the Related Art

An oscillator is typically a component of a receiver and performs frequency conversion in a communication system. Among all specifications of an oscillator, the most important item is phase noise. Phase noise directly influences signal to noise ratio of a receiver, adjacent channel rejection, bandwidth of a transmitter and so forth. With modern communication systems migrating to higher frequencies and multiple frequency bands to meet higher transmission rate requirements, a compatible low phase noise oscillator is playing a more important role in communication systems. In integrated circuits, an oscillator is typically constructed with cross-coupled LC tanks, also known as a differential LC oscillator. The oscillator has lower phase noise when compared with a ring oscillator. To satisfy low power consumption and high signal to noise ratio in a communication system, low phase noise has become an important issue. As a result, circuit architecture for phase noise suppresion of a differential LC oscillator, or so-called noise filter, is provided.

A conventional noise filter in disclosed differential LC oscillators is constructed with a single LC to form a band-stop cavity. Fixed inductance and capacitance results in applications of a single frequency band instead of multiple ones. Noise suppression by noise filter is related to two factors, Q factor and frequency accuracy of the band-stop cavity. Parasitic devices play more important roles in integrated circuits as operating frequency increases, resulting in lower Q-factor of an inductor and narrower frequency range. In addition, resonant frequency of the band-stop cavity also varies with the parasitic devices. Accordingly, such a noise filter is not applicable to a high frequency and multiple band system.

FIG. 1A is a circuit diagram of a differential LC oscillator without a current source and FIG. 1B a diagram showing waveforms of an output voltage and load impedance of the differential LC oscillator in FIG. 1A. When oscillation starts, a high voltage swing is provided between the differential output terminals. As a result, a gate to drain voltage (VGD) of the transistor Q2 is higher than a threshold voltage Vt there of, leading to operation in a triode region. A gate to drain voltage of the other transistor Q1 is much lower than −Vt, leading to a turned-off state. When the differential output voltage becomes higher, a channel resistance rds of the transistor Q2 operated in a triode region becomes lower and forms a current path to AC ground, resulting in power dissipation of the resonator. In a full oscillation cycle, the transistors Q1 and Q2 in the differential pair alternately operate a triode region. Such a mechanism makes the transistors Q1 and Q2 loads to ground of the resonator at a frequency twice that of the oscillation frequency. An average impedance to ground in an oscillation cycle is thus lowered, leading to lower Q-factor of the resonator and higher phase noise of the oscillator.

FIG. 2A is a circuit diagram of a differential LC oscillator with a current source and FIG. 2B a diagram showing waveforms of an output voltage and load impedance of the differential LC oscillator in FIG. 2A. When oscillation starts, one of the transistors Q1 and Q2 enters a triode region. Since an input impedance of the ideal current source I is infinite, there is no current path to AC ground. In addition, since a low impedance of a transistor, such as the transistor Q2 in FIG. 2, operating in a triode region does not becomes a load of a resonant cavity, Q-factor does not degrade. The current source I provides a DC bias and a high impedance to ground to the differential pair of the differential oscillator. In a balanced circuit, an odd harmonic signal flows along a differential path and an even harmonic signal along a common-mode path.

In the disclosed circuit in FIG. 1A, the mechanism leading to lower Q-factor is resulted from low impedance of the common source of the differential pair for even harmonic waves. Accordingly, all that the current source needs to accomplish is to provide a high impedance to even harmonic waves. Since a secondary harmonic 2ω₀ is a major component of the even harmonic waves, a high impedance is provided only for the secondary harmonic. Thus, phase noise is suppressed without sacrificing Q-factor.

FIG. 3 is a circuit diagram of an LC oscillator with a band-stop resonant cavity noise filter. As shown in FIG. 3, a current source M and a large capacitor C1 connected in parallel are connected to ground and form a noise filtering path of the current source M. An inductor L is between the common source CM of the differential pair and the current source M such that all parasitic capacitors C2 associated with the common source CM form a band-stop resonant cavity with a frequency 2ω₀. In other word, a high impedance is provided at the common source CM at a frequency 2ω₀. Resonant frequency accuracy of the band-stop resonant cavity and Q-factor determine performance of the noise filter. In a very high frequency application, inductance may be smaller than 1 nH. In addition, such a low inductance and high Q-factor are not easily achieved by spiral inductors. As a result, inductor characteristics and parasitic capacitance of the common source needs to be precisely controlled, or performance of the noise filter is limited.

### BRIEF SUMMARY OF THE INVENTION

An embodiment of a noise filter connected to an LC oscillator comprises a transmission line, a DC bias circuit, and a capacitor. The transmission line is connected to the LC oscillator. The DC bias circuit is connected to the transmission line and provides a bias current. The capacitor has one end connected between the transmission line and the DC bias circuit and the other end AC grounded and provides a path to AC ground to the transmission line. A length of the transmission line is odd times that of a quarter-wavelength of a secondary harmonic wave of the LC oscillator.

An embodiment of a noise filter connected to an LC oscillator comprises a DC bias circuit, a plurality of transmission lines, and a plurality of switches. The DC bias circuit provides a bias current. The transmission lines are connected in series and arranged between the DC bias circuit and the LC oscillator. Each of the switches has one end connected to a corresponding transmission line and the other end AC grounded via a corresponding capacitor. A total length of the transmission lines is odd times that of a quarter-wavelength of a secondary harmonic wave of the LC oscillator by controlling the switches.

An embodiment of a noise filter connected to an LC oscillator comprises a plurality of transmission lines and a plurality of switches. The transmission lines are connected in series to the LC oscillator. Each of the switches has one end connected to a corresponding transmission line and the other end AC grounded via a corresponding capacitor. A total length of the transmission lines is odd times that of a quarter-wavelength of a secondary harmonic wave of the LC oscillator by controlling the switches.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a circuit diagram of a differential LC oscillator without a current source;

FIG. 1B a diagram showing waveforms of an output voltage and load impedance of the differential LC oscillator in FIG. 1A;

FIG. 2A is a circuit diagram of a differential LC oscillator with a current source;

FIG. 2B a diagram showing waveforms of an output voltage and load impedance of the differential LC oscillator in FIG. 2A;

FIG. 3 is a circuit diagram of an LC oscillator with a band-stop resonant cavity noise filter;

FIG. 4 is a schematic diagram of a transmission line for describing impedance characteristics of a transmission line circuit;

FIG. 5 is a schematic diagram showing relationships between voltage, current and impedance of a transmission line with one end grounded;

FIG. 6A is a circuit diagram of a noise filter of an LC oscillator with a single frequency band transmission line according to an embodiment of the invention;

FIG. 6B is a circuit diagram of a noise filter of an LC oscillator with a single frequency band transmission line according to another embodiment of the invention;

FIG. 7 is a circuit diagram of a noise filter of an LC oscillator with multiple frequency band transmission lines according to another embodiment of the invention;

FIG. 8A is a circuit diagram of a noise filter of a cross-coupled PMOS LC oscillator with multiple frequency band transmission lines according to yet another embodiment of the invention;

FIG. 8B is a circuit diagram of a noise filter of a cross-coupled PMOS LC oscillator with multiple frequency band transmission lines according to yet another embodiment of the invention;

FIG. 9 is a circuit diagram of a noise filter of cross-coupled complementary LC oscillator with multiple frequency band transmission lines according to another embodiment of the invention.

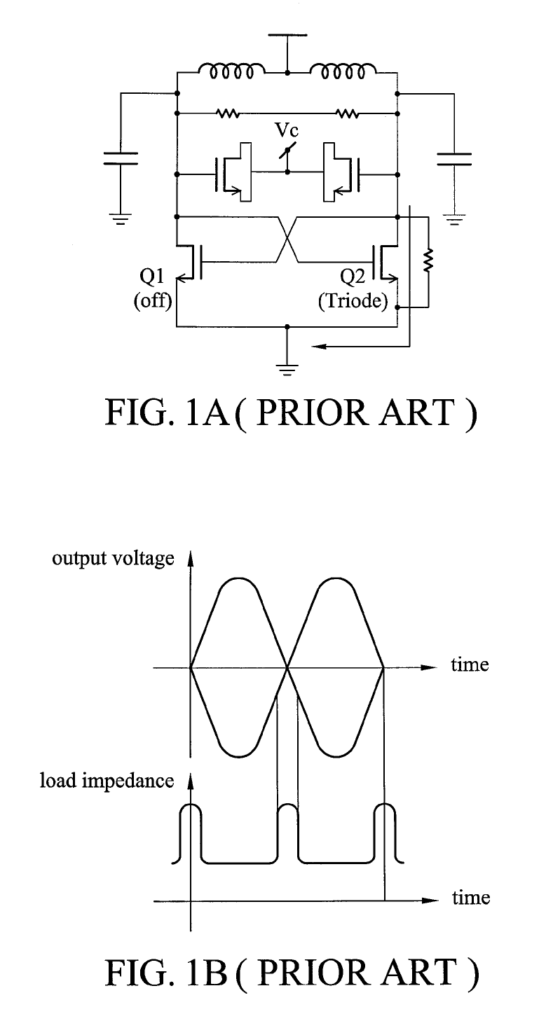

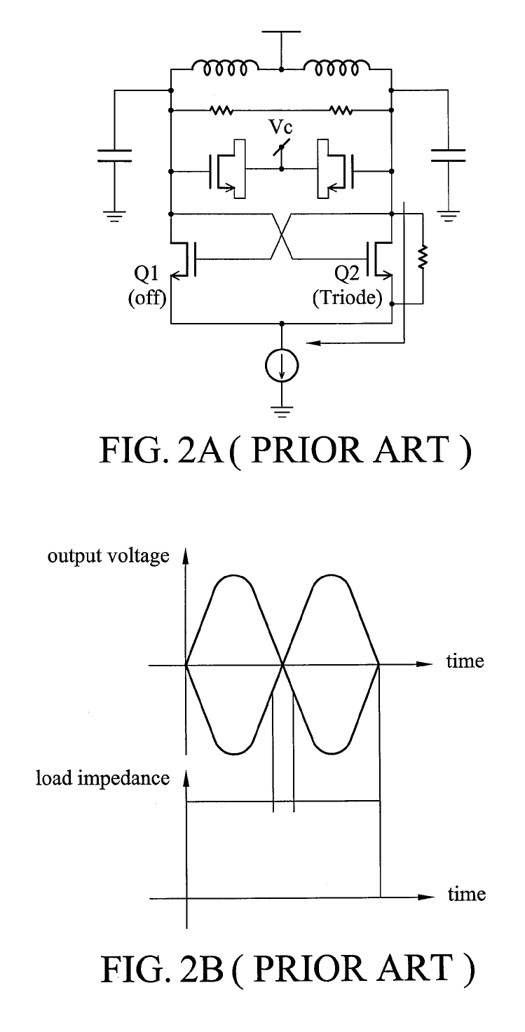

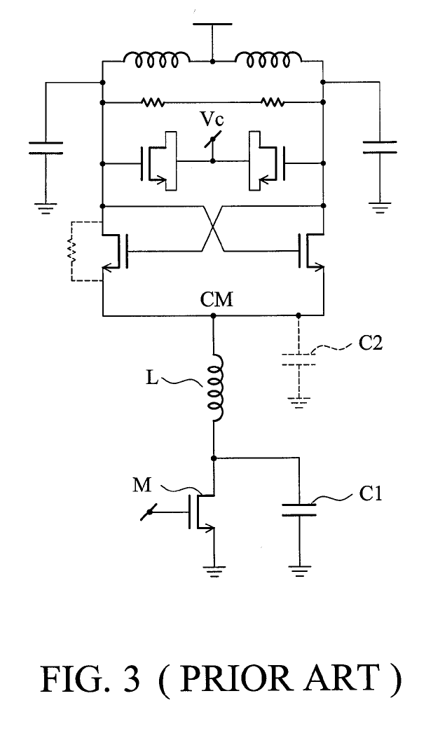

### DETAILED DESCRIPTION OF THE INVENTION

The following description is the best-contemplated mode of carrying out the invention. This description is made for the purpose of illustrating the general principles of the invention and should not be taken in a limiting sense. The scope of the invention is best determined by reference to the appended claims.

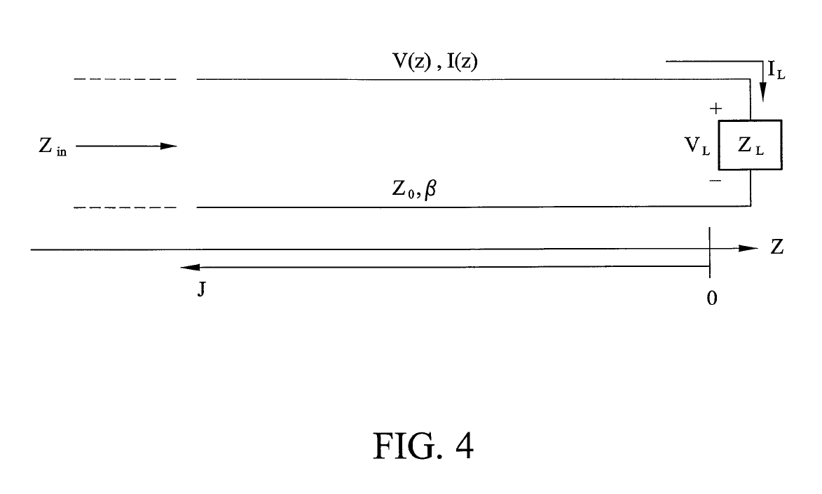

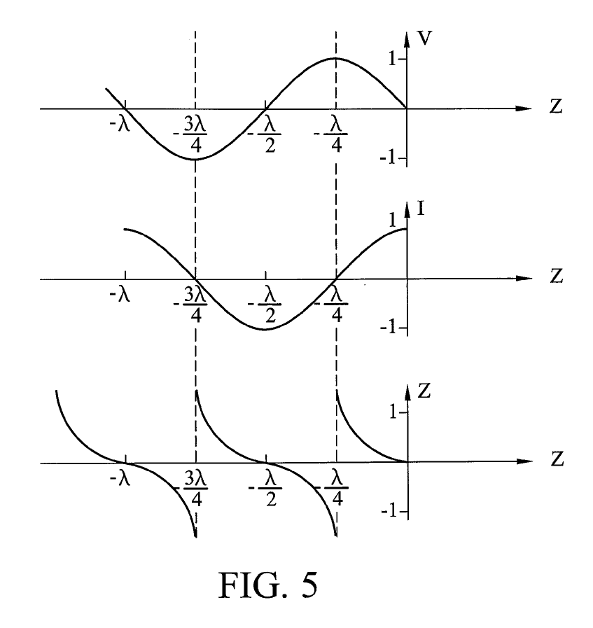

FIG. 4 is a schematic diagram of a transmission line for describing impedance characteristics of a transmission line circuit. Input impedance Zin of a transmission line is typically defined as

$${Z}_{i n} = {Z}_{0} \frac{{Z}_{L} + {jZ}_{0} tan β l}{{Z}_{0} + {jZ}_{L} tan β l} ,$$

wherein Z0 is characteristic impedance of a transmission line, Z₀ is characteristic impedance of a transmission line, Z_{L} is a load impedance and l is a length of the transmission line. When one end of the transmission line is grounded, i.e, the load impedance Z_{L} is 0, the input impedance is simplified as Zᵢₙ=jZ₀ tan βl. When the length of the transmission line equals a quarter-wave length λ/4, the input impedance becomes ∞, leading to a state of high input impedance.

FIG. 5 is a schematic diagram showing relationships between voltage, current and impedance of a transmission line with one end grounded. A voltage V equals 0 and current I has maximum value at z=0. At locations where a length of the transmission line equals odd times that of a quarter-wave length, voltage V has a maximum value and current I is 0. In other words, the impedance Z is approximately infinite, leading to an open state. When such a principle is applied to construction of a noise filter, high impedance is generated by using a transmission line with a length of a quarter wavelength of 2ω₀.

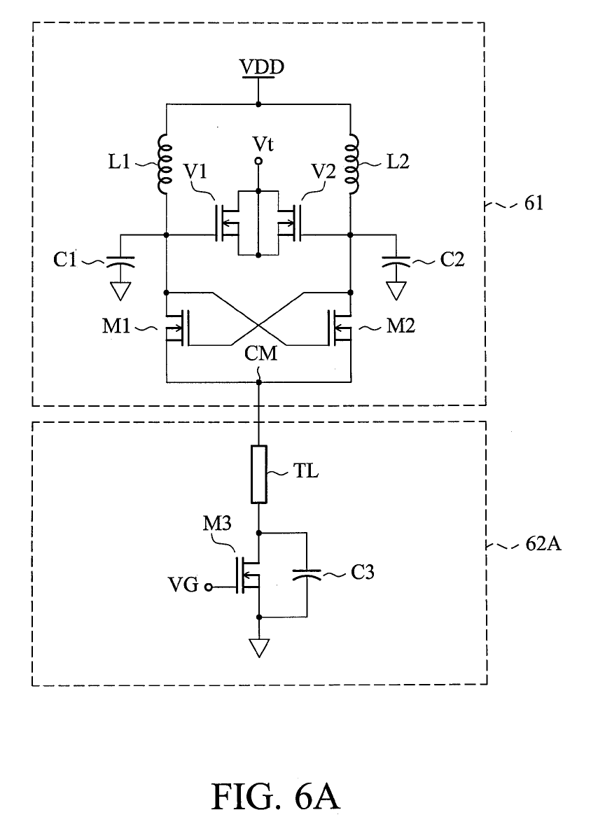

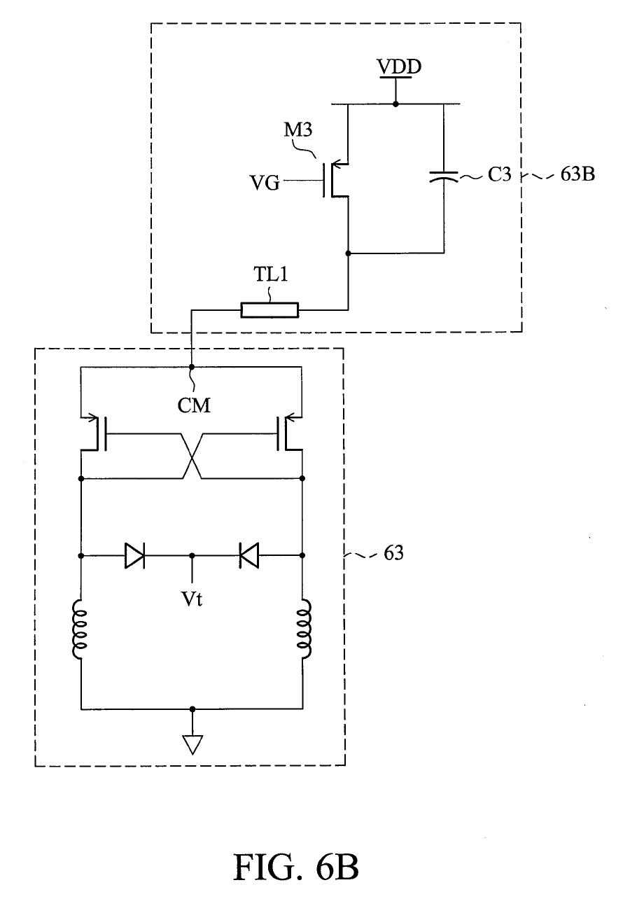

FIG. 6A is a circuit diagram of a noise filter of an LC oscillator with a single frequency band transmission line according to an embodiment of the invention. Transistors M1 and M2 of the cross-coupled NMOS LC oscillator 61 form a cross coupled differential pair. The capacitors C1, C2, the inductors L1, L2, and the transistors V1, V2 collectively form a resonant cavity of an oscillator which determines oscillation frequency ω₀. The noise filter with a single frequency band transmission line 62A comprises a transmission line TL, a grounding capacitor C3 and a current source M3, wherein the current source M3 (DC bias circuit) provides a stable bias current to the oscillator 61. The grounding capacitor C3 provides noise filtering to the current source M3 and AC grounding to the transmission line TL. A length of the transmission line TL between the common source CM and the current source M3 equals a quarter wavelength of a secondary harmonic 2ω₀ of the oscillator 61. If the grounding capacitor C3 is large enough, the grounding capacitor C3 of the transmission line TL is AC short to ground according to the disclosed transmission line principle, i.e, load impedance is 0. After impedance conversion of the transmission line with a length of a quarter wavelength of a secondary harmonic 2ω₀, the common source CM of the differential pair is AC open to the secondary harmonic wave 2ω₀, resulting in high impedance to the secondary harmonic wave 2ω₀. Accordingly, the loading effect of the channel impedance of the differential pair does not leading to lower Q-factor and higher phase noise in the oscillation cycle.

FIG. 6B is a circuit diagram of a noise filter of an LC oscillator with a single frequency band transmission line according to another embodiment of the invention. The cross-couple PMOS LC oscillator 63 is connected to a single frequency band transmission line noise filter 63B. As previously disclosed, the single frequency band transmission line comprises a transmission line TL, an AC grounding capacitor C3 and a current source M3, wherein the current source M3 (DC bias circuit) provides a stable bias current to the oscillator 63. The grounding capacitor C3 provides noise filtering to the current source M3 and AC grounding to the transmission line TL. A length of the transmission line TL between the common source CM and the current source M3 equals a quarter wavelength of a secondary harmonic 2ω₀ of the oscillator 63. Similarly, after impedance conversion of the transmission line with a length of a quarter wavelength of a secondary harmonic 2ω₀, the common source CM of the differential pair is AC open to the secondary harmonic wave 2ω₀, resulting in high impedance to the secondary harmonic wave 2ω₀.

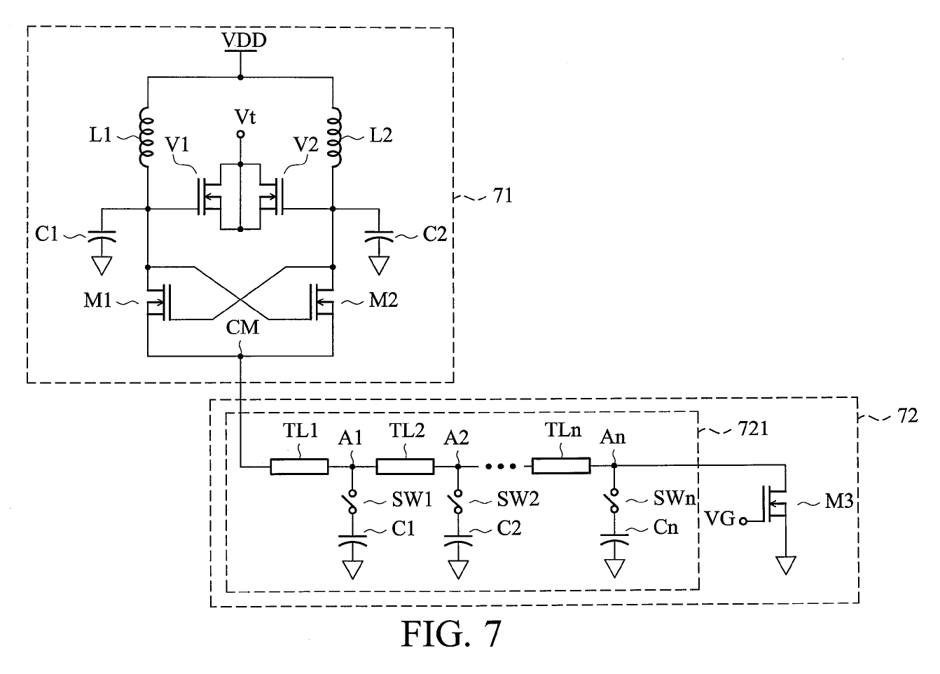

FIG. 7 is a circuit diagram of a noise filter of an LC oscillator with multiple frequency band transmission lines according to another embodiment of the invention. The transistors M1 and M2 of the cross-coupled NMOS LC oscillator 71 form a cross coupled differential pair. The capacitors C1, C2, the inductors L1, L2, and the transistors V1, V2 collectively form a resonant cavity of an oscillator which determines oscillation frequency ω₀. The multiple frequency band transmission lines noise filter 72 comprises a current source M3 and a filter circuit 721, wherein the current source M3 provides a stable current to the oscillator 71. The filter circuit 721 comprises transmission lines TL1, TL2, . . . , TLn, capacitors C1, C2, . . . , Cn and switches SW1, SW2, . . . , SWn. If the oscillator is required to generate multiple frequencies f1, f2, . . . , fn (f1>f2> . . . >fn), lengths of the transmission lines and the oscillation frequencies have the following relationships,

$$\frac{λ ( 2 {f}_{1} )}{4} = {TL}_{1} \\ \frac{λ ( 2 {f}_{2} )}{4} = {TL}_{1} + {TL}_{2} \\ \frac{λ ( 2 {f}_{n} )}{4} = {\sum }_{N = 1}^{N = n} {TL}_{N} \qquad ( 1 )$$

When the oscillation frequency is the highest frequency f1, the switch SW1 is closed and other ones (SW2˜SWn) are opened. The transmission line TL1 is coupled to the grounding capacitor C1 via the switch SW1, resulting in AC ground at the point A1. Since the formula (1) is satisfied, a length of the transmission line TL1 equals a quarter wavelength of second harmonic wave 2f1. Thus, a noise filter for the frequency f1 is formed. Since the point A1 is AC grounded, the following transmission lines (TL2, . . . , TLn) do not affect the transmission line TL1.

When the oscillation frequency is the frequency f2, the switch SW2 is closed and other ones (SW1, SW3˜SWn) are opened. The transmission lines TL1 and TL2 are connected in series and are coupled to the grounding capacitor C2 via the switch SW2, resulting in AC ground at the point A2. Since the formula (1) is satisfied, a total length of the transmission lines TL1 and TL2 equals a quarter wavelength of second harmonic wave 2f2. Thus, a noise filter for the frequency f2 is formed.

When the oscillation frequency is the lowest frequency fn, the switch SWn is closed and other ones (SW1˜SWₙ₋₁) are opened. The transmission lines TL1, TL2, . . . and TLn are connected in series and are coupled to the grounding capacitor Cn via the switch SWn, resulting in AC ground at the point An. Since the formula (1) is satisfied, a total length of the transmission lines TL1, TL2, . . . and TLn equals a quarter wavelength of second harmonic wave 2fn. Thus, a noise filter for the frequency f2 is formed.

As previously disclosed, each of the capacitors C1, C2, . . . , Cn provides AC ground to a corresponding transmission line. Since one of the switches is closed at any one of the frequencies, each of the capacitors C1, C2, . . . , Cn can be used for noise filtering for the current source M3 (DC bias circuit). For a DC current, in an operation mode at any one of the frequencies, the current path comprises the transmission line TL1, TL2, . . . , and TLn. As a result, there is no difference to DC current between different frequencies. For n different oscillation frequencies, lengths of n transmission lines can be properly designed such that noise filtering for high frequency and multiple frequency band application is accomplished.

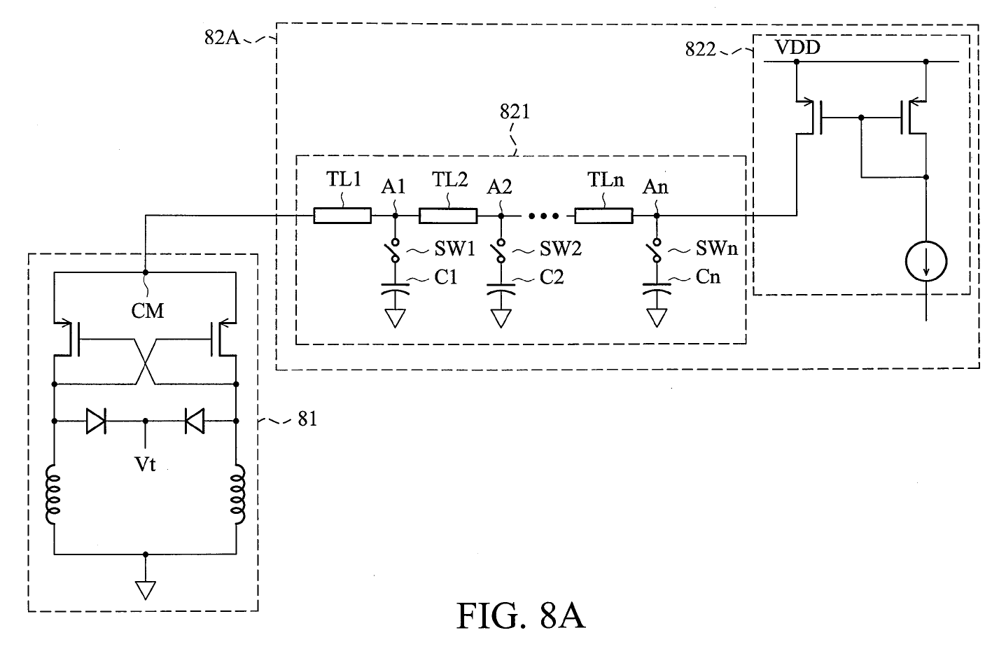

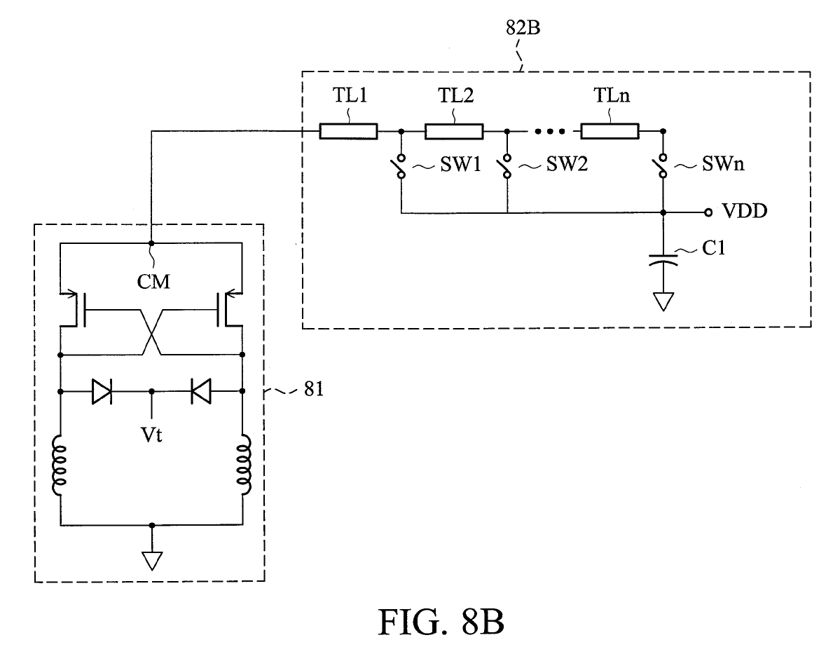

Circuit construction is not limited to the cross-coupled NMOS LC oscillators as shown in FIGS. 6 and 7. FIG. 8A is a circuit diagram of a noise filter of a cross-coupled PMOS LC oscillator with multiple frequency band transmission lines according to yet another embodiment of the invention. The cross-coupled PMOS LC oscillator 81 is connected to a multiple frequency band transmission line noise filter 82A. The multiple frequency band transmission line noise filter 82A comprises a filter circuit 821 and a DC bias circuit 822. The filter circuit 821 is similar to the one in FIG. 7 and comprises transmission lines TL1, TL2, . . . , TLn, capacitors C1, C2, . . . , Cn and switches SW1, SW2, . . . , SWn. The DC bias circuit 822 can be a current mirror, as shown in FIG. 8A. DC bias circuit in FIG. 8A is modified according to power structure of the cross-coupled PMOS LC oscillator 81 and operation of the transmission lines, capacitors, and switches is similar to that in FIG. 7.

For different power structures in a cross-coupled PMOS LC oscillator 81, a noise filter with multiple frequency band transmission lines is disclosed as shown in FIG. 8B. FIG. 8B is a circuit diagram of a noise filter of a cross-coupled PMOS LC oscillator with multiple frequency band transmission lines according to another embodiment of the invention. From comparison between the multiple frequency band transmission line noise filter 82B and the one 82A in FIG. 8A, the major difference is that the transmission lines TL1, TL2, . . . , TLn share one capacitor C1 via switching of the switches of the switches SW1, SW2, . . . , SWn. The power VDD is coupled between the switches and the capacitor C1. Operation principle thereof is the same as previously disclosed. Switching of the switches is controlled according to frequency of the oscillator 81 and lengths of the transmission lines are selected according to a quarter wavelength of a second harmonic wave.

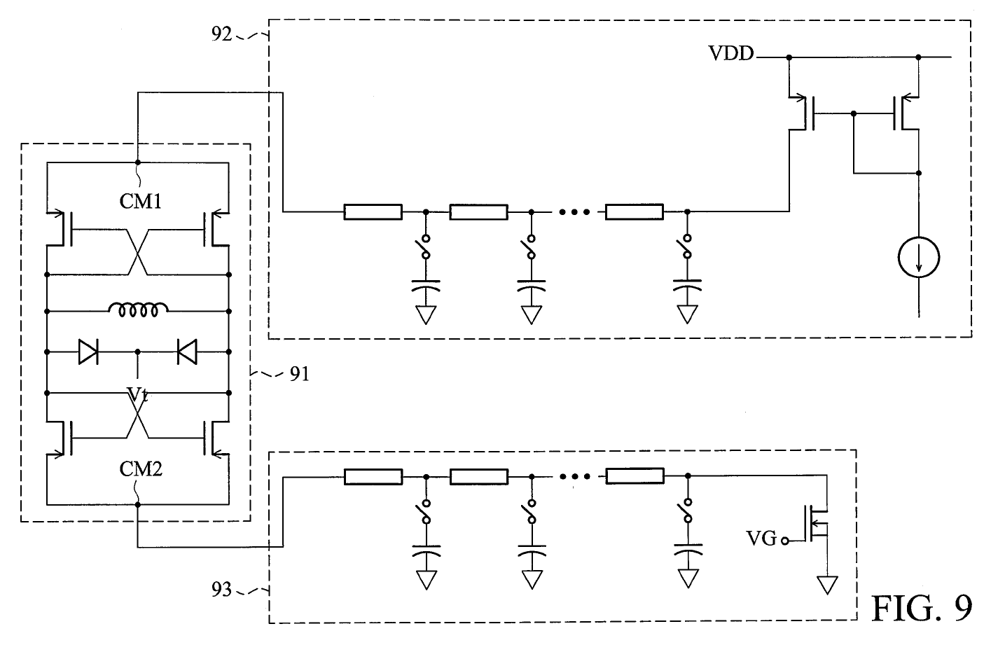

FIG. 9 is a circuit diagram of a noise filter of cross-coupled complementary LC oscillator with multiple frequency band transmission lines according to another embodiment of the invention. A common source CM1 of the cross-coupled complementary LC oscillator 91 is connected to a first multiple frequency band transmission line noise filter 92 and another common source CM2 is connected to a second multiple frequency band transmission line noise filter 93. It is found that the first multiple frequency band transmission line noise filter 92 in FIG. 9 is the same as the one 82A in FIG. 8A or the one 82B in FIG. 8B and the second multiple frequency band transmission line noised filter 93 is the same as the one 72 in FIG. 7. Operation principles of the first and second multiple frequency band transmission line noise filter are the same as previously disclosed. Based on frequencies of the cross-coupled complementary LC oscillator 91, an appropriate total length of the transmission lines is selected via the switches according to the formula (1). A total length of the transmission lines equals a quarter wavelength of secondary harmonic wave 2f, resulting in high impedance at the common sources CM1 and CM2 such that noise of frequency f is suppressed.

It is noted that the transmission lines in the disclosed noise filters can be constructed in any possible way. The transmission line comprises a strip line, a microstrip line, a coplanar waveguide and the like. The DC bias circuit and the switches can be constructed in any possible way. The DC bias circuit and the switches comprise MOS transistors, MESFETs, BJTs, diodes, and the like. It is noted in the disclosed embodiments, the transmission line is coupled between the LC oscillator and the DC bias circuit. However, the scope of the invention is not limited thereto. Coupling the DC bias circuit between the transmission line and the LC oscillator is also applicable to the invention.

A noise filter according to embodiments of the invention can be applied to different configurations of an LC oscillator. A total length of the transmission line is designed as a quarter wavelength of a secondary harmonic wave such that noise filtering is accomplished.

While the invention has been described by way of example and in terms of preferred embodiment, it is to be understood that the invention is not limited thereto. To the contrary, it is intended to cover various modifications and similar arrangements as would be apparent to those skilled in the Art. Therefore, the scope of the appended claims should be accorded the broadest interpretation so as to encompass all such modifications and similar arrangements.

What is claimed is:

1. A noise filter, coupled to an LC oscillator and comprising:
a transmission line coupled to the LC oscillator; and
a DC bias circuit, coupled to the transmission line and providing a bias current;
wherein a length of the transmission line is odd times that of a quarter-wavelength of a secondary harmonic wave of the LC oscillator.

2. The noise filter as claimed in claim 1, further comprising a capacitor having one end coupled between the transmission line and the DC bias circuit and the other end AC grounded and providing a path to AC ground to the transmission line.

3. The noise filter as claimed in claim 1, wherein the transmission line is a strip line, a microstrip line, or a coplanar waveguide.

4. The noise filter as claimed in claim 1, wherein the DC bias circuit is constructed with MOS transistors, MESFETs, BJTs, or diodes.

5. The noise filter as claimed in claim 1, wherein the LC oscillator is an NMOS cross-coupled LC oscillator, a PMOS cross-coupled LC oscillator, or a complementary cross-coupled LC oscillator.

6. A noise filter, coupled to an LC oscillator and comprising:
a DC bias circuit providing a bias current;
a plurality of transmission lines coupled in series, and arranged between the DC bias circuit and the LC oscillator; and
a plurality of switches each having one end coupled to a corresponding transmission line and the other end AC grounded,
wherein by controlling the switches, a total length of the transmission lines is odd times that of a quarter-wavelength of a secondary harmonic wave of the LC oscillator.

7. The noise filter as claimed in claim 6, wherein the other end of each of the switches is AC grounded via a corresponding capacitor.

8. The noise filter as claimed in claim 6, wherein the transmission lines are strip lines, microstrip lines, or coplanar waveguides.

9. The noise filter as claimed in claim 6, wherein the DC bias circuit and the switches are constructed with MOS transistors, MESFETs, BJTs, or diodes.

10. The noise filter as claimed in claim 6, wherein the LC oscillator is an NMOS cross-coupled LC oscillator, a PMOS cross-coupled LC oscillator, or a complementary cross-coupled LC oscillator.

11. The noise filter as claimed in claim 6, wherein the LC oscillator is a PMOS cross-coupled LC oscillator and the DC bias circuit is a current mirror.

12. A noise filter, coupled to an LC oscillator and comprising:
a plurality of transmission lines coupled in series to an LC oscillator; and
a plurality of switches each having one end coupled to a corresponding transmission line and the other end AC grounded,
wherein by controlling the switches, a total length of the transmission lines is odd times that of a quarter-wavelength of a secondary harmonic wave of the LC oscillator.

13. The noise filter as claimed in claim 12, wherein the other end of each of the switches is AC grounded via a corresponding capacitor.

14. The noise filter as claimed in claim 12, wherein the transmission lines are strip lines, microstrip lines, or coplanar waveguides.

15. The noise filter as claimed in claim 12, wherein the switches are constructed with MOS transistors, MESFETs, BJTs, or diodes.

16. The noise filter as claimed in claim 12, wherein the LC oscillator is an NMOS cross-coupled LC oscillator, a PMOS cross-coupled LC oscillator, or a complementary cross-coupled LC oscillator.

17. The noise filter as claimed in claim 12, wherein a voltage source is coupled between the switches and the capacitors.

18. A method for filtering noise of an LC oscillator comprising:
acquiring oscillating frequency of an LC oscillator; and
providing a transmission line of an appropriate length and coupling the same to the LC oscillator;
wherein the length of the transmission line is odd times that of a quarter-wavelength of a secondary harmonic wave of the LC oscillator.

19. The method as claimed in claim 18, wherein the length of the transmission line is adjusted by switching a plurality of switches.
